(19) United States
(12) Patent Application Publication
(10) Pub. No.: US 2025/0259562 A1
(43) Pub. Date: Aug. 14, 2025

(54) METHOD AND APPARATUS FOR PROCTORING AN EXAMINATION

(71) Applicant: National Checking Company, St. Paul, MN (US)

(72) Inventor: Dominic Pease, St. Paul, MN (US)

(21) Appl. No.: 18/742,770

(22) Filed: Jun. 13, 2024

Related U.S. Application Data
(60) Provisional application No. 63/507,591, filed on Jun. 12, 2023.

(51) Int. Cl. G09B 7/00; H04L 9/30

(52) U.S. Cl. CPC G09B 7/00; H04L 9/30

(57) ABSTRACT

A method and apparatus for administering, conducting, and proctoring an examination. In particular, the present invention relates to: a method and apparatus for administering, conducting, and proctoring an examination given electronically that may use a central or remote network connection; a computer based method to encrypt an exam across multiple devices until a decryption key is provided; a computer based method for selectively re-securing examination data during a test based on the condition of the examinee's computing device; and a computer based method of transmitting a completed exam without the aid of a central or remote computer network based on cryptography key distribution.

### RELATED APPLICATIONS

The present application claims priority to and incorporates by reference U.S. Provisional Patent Application No. 63/507,591 filed on Jun. 12, 2023.

### BACKGROUND OF THE INVENTION

### Field of the Invention

This invention relates to a method and apparatus for administering, conducting, and proctoring an examination. In particular, the present invention relates to: a method and apparatus for administering, conducting, and proctoring an examination given electronically that may use a central or remote network connection; a computer based method to encrypt an exam across multiple devices until a decryption key is provided; a computer based method for selectively re-securing examination data during a test based on the condition of the examinee's computing device; and a computer based method of transmitting a completed exam without the aid of a central or remote computer network based on cryptography key distribution.

### BACKGROUND

Computer administrated test-taking methods and devices are known in the art. It is common to take a test online, or through computer devices that are linked through some sort of central network connection. This can include remote networks such as the internet, or creating local networks between the computing devices of a plurality of test takers, and the test administrator/proctor device.

For example, digital proctoring systems in which proctors use computers or mobile devices to monitor exam-takers who are also using computers or mobile devices are known. Some systems utilize web-based proctoring and test taking methods, in which the interaction between the proctor and test takers devices is brokered by a central web server. Some systems allow proctors to monitor exams from a remote location, and allow the test takers to be remotely located from each other and the proctor.

These systems have a number of benefits for both the test takers, proctors, and organizations that offer the tests. These benefits include eliminating paperwork, increasing data security, and allowing a proctor to monitor more examinees than possible in a live testing environment and with less effort than non-digital solutions.

There are, however, a number of drawbacks to these systems. In particular, prior art digital proctoring systems involving more than one device have a drawback in their reliance on the availability of a multi-access point computer network (such as the Internet or a wireless LAN) in order to operate reliably and without interruption to the exam and/or monitoring process. If some or all of the participants lose their connection to the network, the proctoring systems are no longer reliable and typically no longer function. This can happen through inadvertent loss of connection, or intentional losses associated with cheating or other attempts to game the system.

Several additional drawbacks also apply to known digital proctoring systems. For example: the proctor may be required to interact with the examinee's device in an insecure way, such as by entering their own username and password on an untrusted device, the system may be susceptible to the loss of an examinee's data (such as test answers), and the system may not prevent, or adequately prevent, the examinee from cheating or stealing test data.

Thus, a need exists for an electronic computer based proctoring system that can reliably administer a test across multiple participants' devices without suffering from the drawbacks associated with network connectivity unreliability.

### BRIEF DESCRIPTION OF THE FIGURES

FIG. 1 is a flow chart of the steps of the present invention.

FIG. 2A shows a screen shot of the proctor's device.

FIG. 2B shows a screen shot of the examinee's device.

FIG. 3A shows a screen shot of the proctor's device.

FIG. 3B shows a screen shot of the examinee's device.

FIG. 4A shows a screen shot of the proctor's device.

FIG. 4B shows a screen shot of the examinee's device.

FIG. 5A shows a screen shot of the proctor's device.

FIG. 5B shows a screen shot of the examinee's device.

FIG. 6A shows a screen shot of the proctor's device.

FIG. 6B shows a screen shot of the examinee's device.

FIG. 7A shows a screen shot of the proctor's device.

FIG. 7B shows a screen shot of the examinee's device.

FIG. 8A shows a screen shot of the proctor's device.

FIG. 8B shows a screen shot of the examinee's device.

FIG. 9A shows a screen shot of the proctor's device.

FIG. 9B shows a screen shot of the examinee's device.

FIG. 10A shows a screen shot of the proctor's device.

FIG. 10B shows a screen shot of the examinee's device.

FIG. 11A shows a screen shot of the proctor's device.

FIG. 11B shows a screen shot of the examinee's device.

FIG. 12A shows a screen shot of the proctor's device.

FIG. 12B shows a screen shot of the examinee's device.

FIG. 13A shows a screen shot of the proctor's device.

FIG. 13B shows a screen shot of the examinee's device.

FIG. 14A shows a screen shot of the proctor's device.

FIG. 14B shows a screen shot of the examinee's device.

FIG. 15A shows a screen shot of the proctor's device.

FIG. 15B shows a screen shot of the examinee's device.

### DETAILED DESCRIPTION OF THE PREFERRED EMBODIMENTS

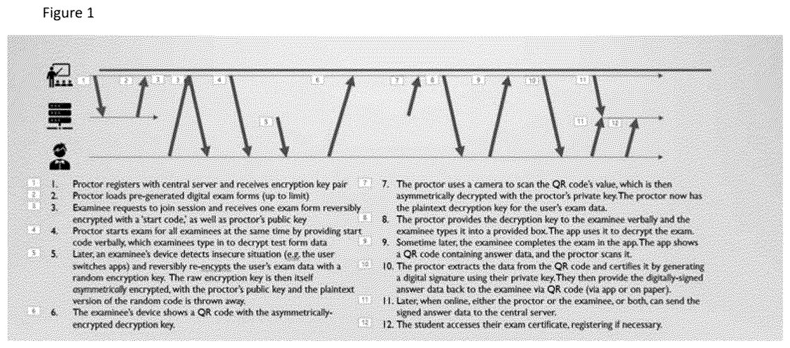

In [symbol] FIGS. 1-15B, a computer implemented method for proctoring an exam is shown, along with an apparatus for the same. Generally, the present invention relates to a proctoring system wherein a proctor monitors from a first electronic device, and individuals partaking in a test taking activity utilize a plurality of additional electronic devices, where the proctor can manage the behavior of the individuals without the reliance on a central computer network connection between the afore mentioned devices. A common instance of this is a digital exam, which is being monitored by a proctor to prevent cheating, exam data theft, or other activity that can interfere with the integrity of the exam.

The present invention comprises a digital proctoring system that can be adapted to systems that use computers or mobile devices to conduct and proctor the exam, where the exam- takers are also using their own computers or mobile devices (such as phones).

The digital proctoring system according to the present invention aims to address the problems associated with the prior art by using other means of communication between devices than an internal or external computer network, which means may be used for the entire exam or only when a more conventional means of communication is periodically unavailable.

Another embodiment of the digital proctoring system of the present invention is that public key cryptography may be used to ensure that data generated during offline test taking can be securely transmitted to a central system of records and the authenticity of the data guaranteed without further proctor intervention. This aspect of the invention is particularly useful in case existing computer networks or communications protocols are not functioning and the proctor is prevented from transmitting that information using such networks or protocols.

According to a further embodiment of the digital proctoring system, encryption may be used to “lock” (i.e. secure from unauthorized viewing or use) test data from being accessed (including by a previously-authorized examinee) on an untrusted device such that even repeated lock/unlock conditions require a unique proctor action each time, preventing test data from being stolen, altered, or corrupted.

According to yet another embodiment of the digital proctoring system, the process of multiple examinees joining a proctor's test session can be managed by the system in such a way that the exam contents are encrypted until the exam starts (or restarts), when a proctor can securely enable all examinees to start at the same time, without any device-to-device connection required.

The present invention operates between and amongst at least three different participants/computer devices: the proctor device; a networked server device; and an examinee device. The devices can be general-purpose computers of a variety of types, including desktop computers, laptops, tablets, mobile devices, or dedicated network devices. The device operates under the control of an application (or multiple applications) distributed between the devices, and where the application is capable of communication between the devices. However, the communication between the devices does not have to be continuous, and in fact the system is developed to operate seamlessly in the event of a disruption between the connection between the devices. The application makes use of a generally available encryption program such as those that are based on public/private key encryption.

FIG. 1 shows a flow chart depicting the steps of the system as carried out under the computer control described above. FIG. 1 shows three levels of operation corresponding to the description of participants/devices above. The top level is the exam proctor and his/her device, the middle level is the central computer server/network, and the bottom level is the examinee and his/her device. Arrows show the flow between levels, although the invention is not necessarily limited to the flows shown. The system is designed for simultaneous action between multiple examinees and proctor (or proctors).

In step 1, the proctor establishes a connection with the central server and receives an encryption key pair (public and private key specific to the proctor), which the proctor will use throughout the remainder of the process.

In step 2, the proctor receives the exam forms from the central server, generally up to a specified limit as necessary to administer a particular exam session.

In step 3, the examinee requests to join the exam session. The request can be sent through device connections, or through an in person request. In response to the request, the proctor delivers to the examinee an exam form encrypted with a start code that can decrypt the form, and the proctor provides the proctor's public encryption key for use by the examinee pursuant to the application executing on the examinee device. This delivery can happen electronically either through the central server, through a direct local electronic connection established between the proctor and examinee devices, or other direct communication between the proctor and examinee.

In step 4, after step 3 has been performed for all examinees and the proctor is ready to simultaneously start the exam for all examinees, the proctor delivers the start code that will decrypt the exam. The code can be delivered verbally, by writing the code on a board, or by sending a text/email message. This delivery step does not require the involvement of the central server.

In step 5, if after the exam has started the examinee's device detects a condition that requires stopping the examinee from continuing the examination, the exam is halted on the examinee's device, and the exam is encrypted with a randomly generated symmetric encryption code. This code is then asymmetrically encrypted using the proctor's public encryption key, provided to the examinee when the exam was distributed in Step 3, and the original unencrypted code is disposed of or deleted. A stop condition can include any condition that calls into question the security of the examination, such as if the examinee switches applications, closes the exam application, or any other event associated with a condition that threatens the integrity of the exam.

In Step 6, after the examinee's session is stopped and the codes created, the examinee device displays a QR code on its screen with the asymmetrically encrypted code created with the proctor's public key embedded therein.

In step 7, the proctor then uses his/her device to scan the QR code displayed on the screen of the examinee device. The proctor device can then recover the original key used to encrypt the examinee's test on the examinee device, by using the proctor's private key. The proctor now has the information necessary enable the examinee to resume the test.

In step 8, after the initial stop condition that led to interruption of the exam on the examinee device has been resolved to the satisfaction of the proctor, the proctor can give the decryption key to the examinee to allow the exam to resume. The proctor can provide the code verbally, or through some device-to-device communication protocol such as email or text message, which the examinee can then type into the application on their device that is running the exam thereby allowing the examinee to resume the exam.

In step 9, upon completion of the exam by the examinee, the application on the examinee device encodes the exam answers and displays this information on the screen of the examinee's device as a QR code. The proctor scans the QR code with the proctor device and the application running on the proctor device can extract the test results therefrom. The information contained in this QR code could be communicated in some other device-to-device manner such as through email or text messaging.

In step 10, upon extracting the test results from the QR code, the proctor certifies the results by generating a digital signature using the proctor's private encryption key. The certificate is embedded in a data packet, along with the results of the exam, which is delivered back to the examinee via QR code, through device-to-device communication, on paper, or by some other means.

In step 11, at some later point in time when communication with the central server is available to the proctor or examiner (or both). The data packet containing the exam results and the signature is sent to the central server. If the proctor sends this information to the central server, the proctor's user credentials are enough to verify the authenticity of the data. If, however, the examinee sends the information, the central server can use its stored copy of the proctor's encryption key pair to verify the digital signature generated in step 10, authenticating the integrity of the data packet. The exam results thus validated are then stored as the official record, so that a certificate and certified exam score can be assigned.

In step 12, at any point after step 11 is completed the examinee can access and review the exam results by connecting through the application to the central server.

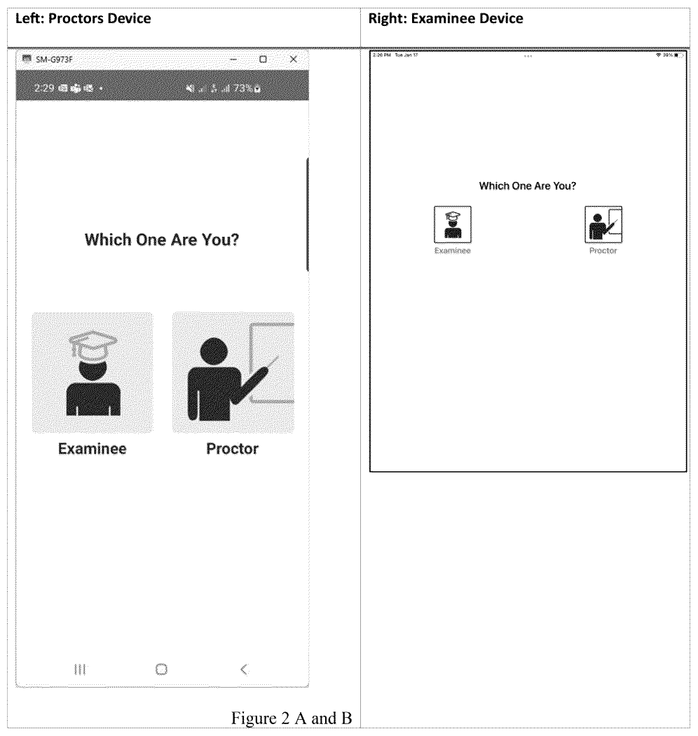

The present invention is carried out as indicated herein pursuant to computer application programs running on the proctor device, examinee device, and the central server. In further detail, FIGS. 2A-15B show screen shots of the applications, including at the various steps described above. The screen shots show both the examinee device screens and the proctor device screen as applicable to the step in the process. The applications running on the aforementioned devices can be one application having different functions depending on which device is used, or the applications can be separated where the examinee and proctor download separate applications.

FIGS. 2A and 2B show an initial screen where the examinee and proctor identify themselves by selecting the user type associated with the particular person using the application.

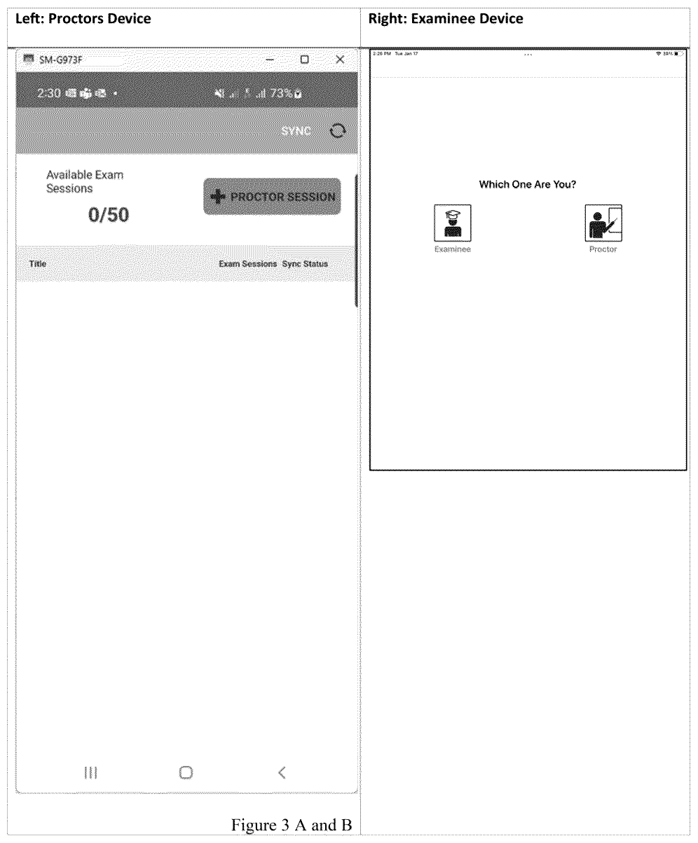

FIGS. 3A and 3B show the screens associated with Step 1 and 2 described above. FIG. 3A shows that the proctor starts with an empty stack of exams, and can load the stack by acquiring the exams from the central server. This step requires a remote connection between the proctor device and the central server for the download. The number of exams available for loading can vary, but a limit is imposed (as shown in the proctor device) to ensure that the number of exams provided to the proctor does not exceed the number a proctor might reasonably be expected to administer during an interval in which connection to the Internet is inconvenient or impossible. This also ensures the proctor connects to the central server from time to time, preventing misuse of the exam and potential loss of examinee data. During the exam acquisition step, the central server also provides the proctor with the public-private encryption keys used throughout the process.

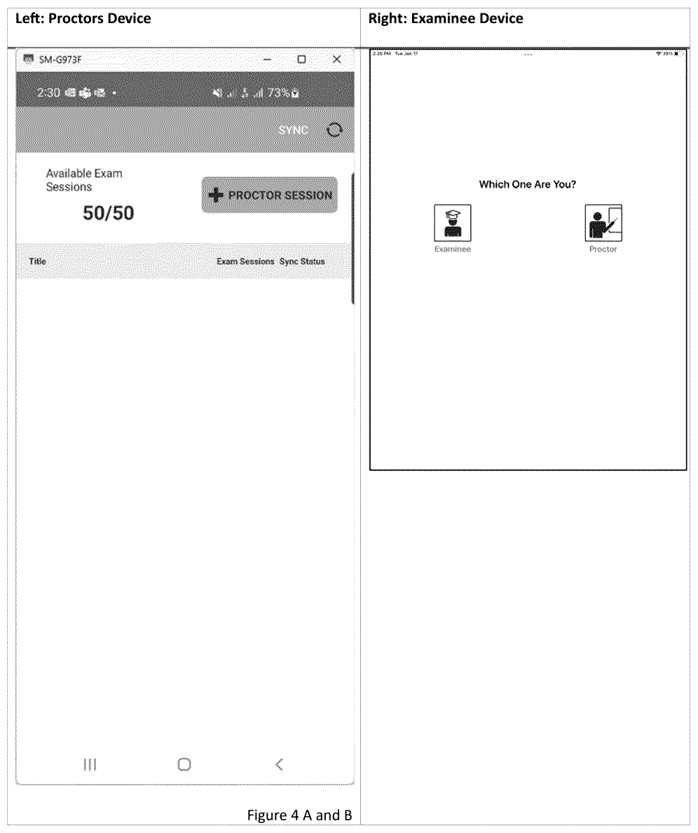

FIG. 4A shows a screen after the encryption credentials and exams have been obtained by the proctor from the central server. At this point connection to the central server, or to a remote computer network, is no longer necessary to complete the exam. If the connection is not available, is not reliable, represents a security threat, or the connection is interrupted for any other reason, the proctor can administer the exam, and the examinees can complete the exam, between their devices alone, and still be able to produce a result that is secure and reliable and deliver the results to the central server a later time. The proctor can proceed with the exam off-line by selecting the Proctor Session button, which creates an off-line capable proctor session. FIG. 4B shows the screen of the examinee device, where a selection can be made to indicate whether the user is the proctor or the examinee.

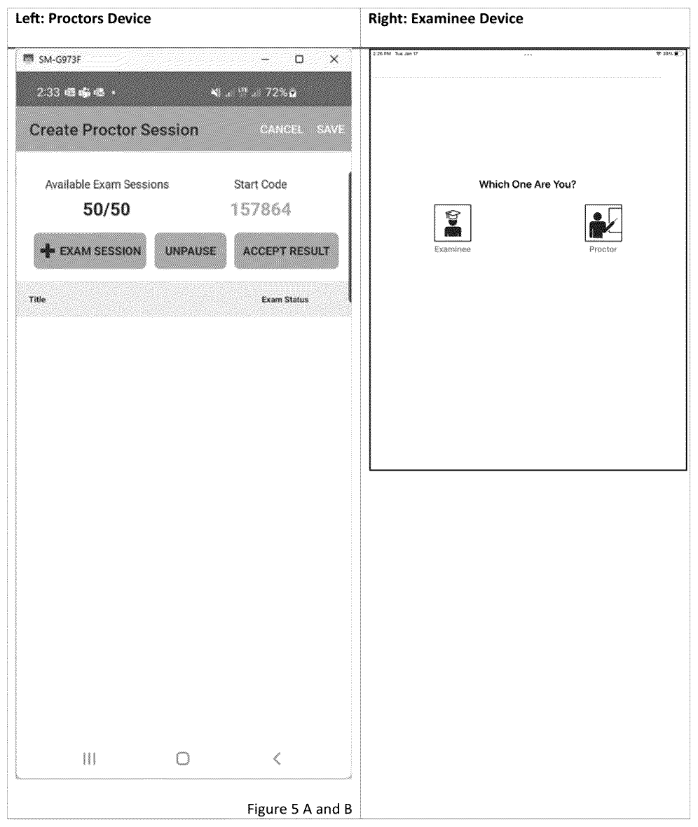

FIG. 5A shows a screen on the proctor device after the exam session has been created showing the options described below for conducting the exam. FIG. 5B shows the same screen of the examinee device that has been shown in FIGS. 2B, 3B, and 4B, where the user can make a selection of proctor or examinee.

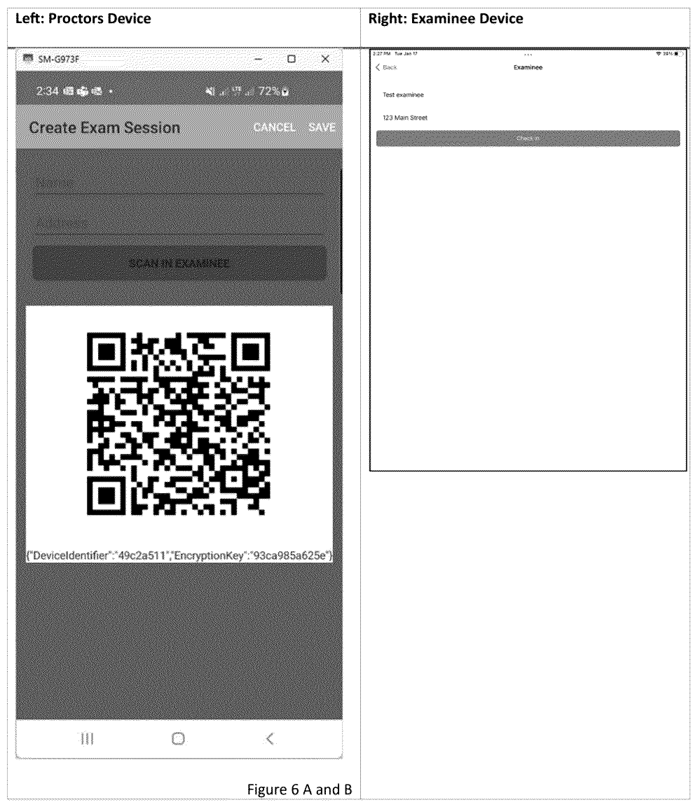

FIG. 6B shows a screen where the examinee fills out the examination registration form on her/his device, and selects the ‘Check In’ option when done filling in the form. FIG. 6A shows that at approximately the same time, after the proctor selected the ‘+Exam Session’ option shown in FIG. 5A, the proctor device is readied for the examinee to join the exam session. A code is generated and embedded in the QR code on the proctor device, which can be provided to the examinee device to establish a connection between the devices for information exchange.

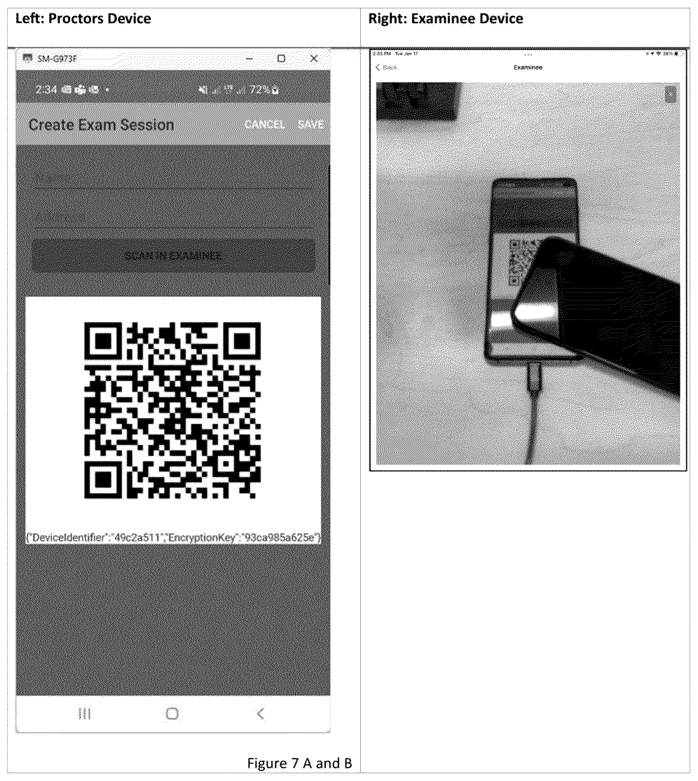

FIG. 7B shows a screen where the examinee device opens a QR code reader on screen, which allows the examinee to scan the QR code referenced above in FIG. 6A. FIG. 7A shows the same screen of the proctor's device as shown in FIG. 6A. A secure peer-to-peer device connection (for example, via Bluetooth LE) is then established between the proctor and examinee devices using the information contained in the QR code. This connection allows the examinee to send their registration data to the proctor and allows the proctor to respond with the exam data and other important session information (including the proctor's public key), and is no longer needed once this exchange is complete.

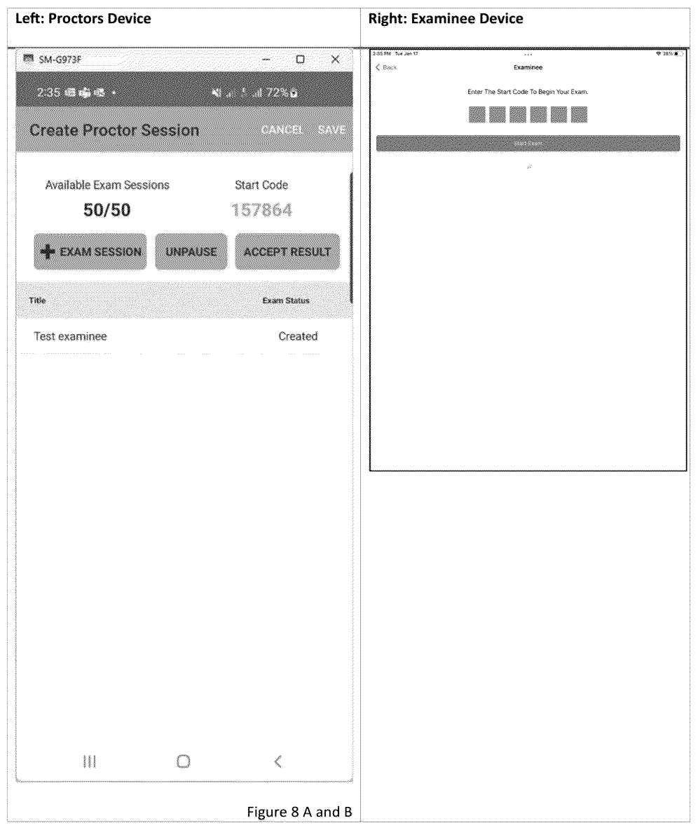

FIGS. 8A and 8B show the screens at a point where the examinee and proctor devices have shared the information referenced above, and both devices are ready to start the examination as set forth in Step 4 above. At this point, the two devices no longer need to remain connected via the peer-to-peer connection mentioned above. The proctor device shown in FIG. 8A lists the examinees, and indicates their status (in this case, the status is that an exam has been created for this examinee and an encrypted version shared therewith). The examinee device shown in 8B is awaiting entry of the start code, which the proctor will provide to decrypt the exam and allow the examinee to begin the exam. If there are multiple examinees, the proctor will repeat the process shown in FIGS. 6A through 7B until all examinees are ready to begin the exam as shown here.

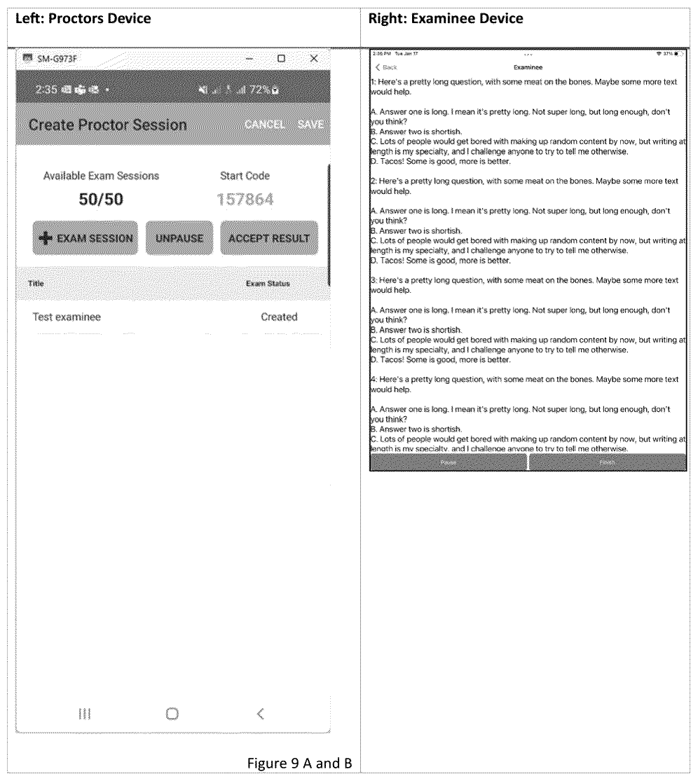

FIG. 9A shows a screen after the start code referenced in Step 4 above has been provided to the examinee. The start code appears on the proctor device. The proctor provides the start code to all examinees verbally or in writing on a black/white board (it could be provided by a group text or email message through a local connection), allowing the examinees to enter the code on their devices and all start the exam at the same time, as shown in FIG. 9B. The code allows each examinee to decrypt their unique exam data into device memory, where it allows the examinee to read, and answer questions on the exam.

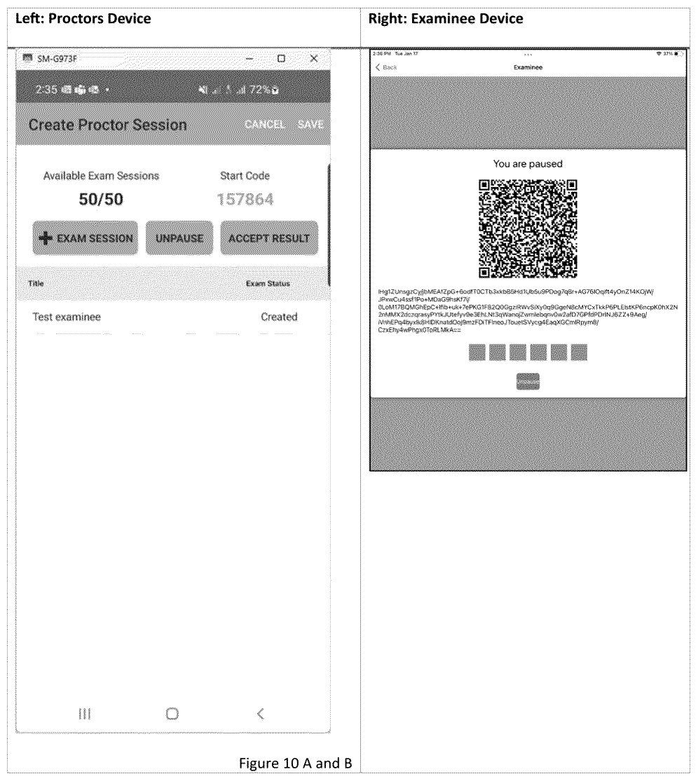

FIG. 10B shows a screen on the examinee device after the exam sessions has been paused for one of the reasons described herein. An examinee's session may become paused, for instance if disallowed behavior is detected that could affect the integrity or security of the exam. The examinee's device chooses a symmetric encryption key (the ‘unpause code’), and uses it to encrypt the exam contents. The unencrypted exam data is deleted or otherwise made unavailable for use while the encrypted version is stored to be ready for later unlocking. Then the unpause code is asymmetrically encrypted with the proctor's public key (again discarding the unencrypted data). The encrypted unpause code is then embedded into a QR code and displayed on the examinee's screen. This corresponds to the activity described in Steps 5-6 above. FIG. 10A shows the proctor's device once the exam has been paused.

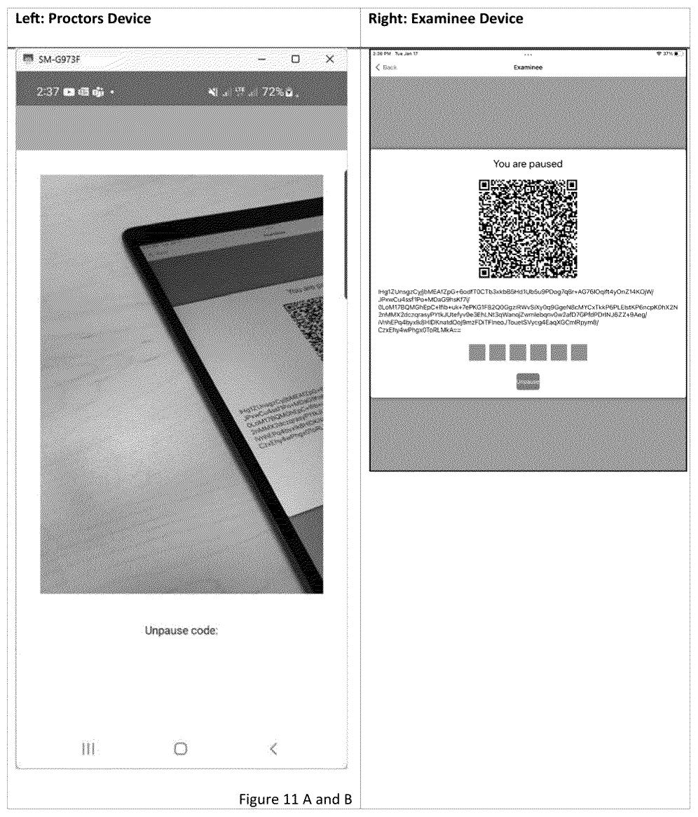

FIG. 11A shows the screen of the proctor device, once it is brought to the proctor's attention that an examinee device is paused, and the proctor selects the ‘Unpause’ button that opens a QR code scanner on the proctor device. The proctor can then physically scan the QR code on the examinee device. This corresponds to the activity described in Step 7 above. The QR code could also be shared via device-to-device communication such as text or email. FIG. 11B shows the examinee device that has been paused, also shown in FIG. 10B.

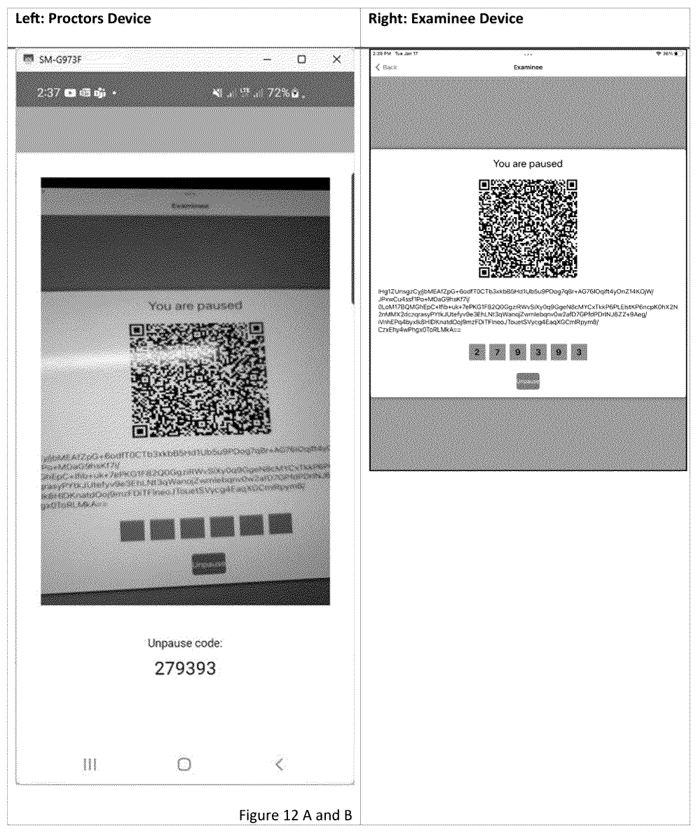

FIG. 12A shows the screen of the proctor device after scanning the QR code on the examinee device associated with the pause event. The QR code scanner reads the QR code and extracts the encrypted unpause code generated as stated above. The proctor's private encryption key is used to decrypt the code that appears on the proctor device. After determining that the examinee can safely resume the exam, the proctor provides the decrypted unpause code to the examinee who then enters the code into the examinee device and resumes taking the exam, as shown in FIG. 12B. The double-encryption process described above is enough to ensure that this code is valid only for this single decryption event on a single examinee device—no other examinee, nor the same examinee during a later pause event, can use/reuse the same unpause code. If another pause event occurs, the process is repeated with a new set of codes. This corresponds to the activity described in Step 8 above.

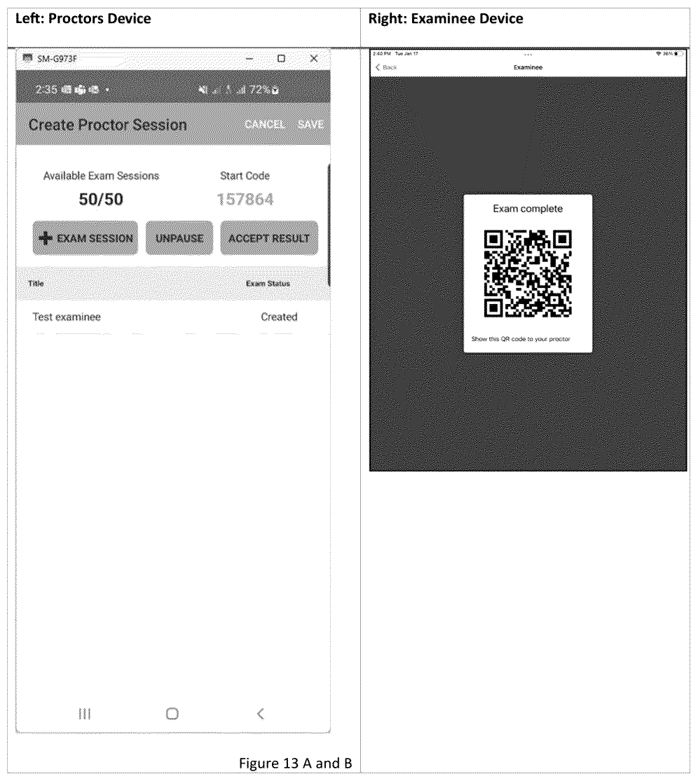

FIG. 13B shows the screen of the examinee device upon completion of the exam, which is displayed after the examinee proceeds through the exam, answering questions and, if becoming paused again, repeating the unpause process as needed. When the examinee is satisfied with their exam answers or the period for examination has expired, they select the ‘finish’ option, and their device presents a final QR code containing the completed exam data. FIG. 13A shows the proctor's screen. This corresponds to the activity described in Step 9 above.

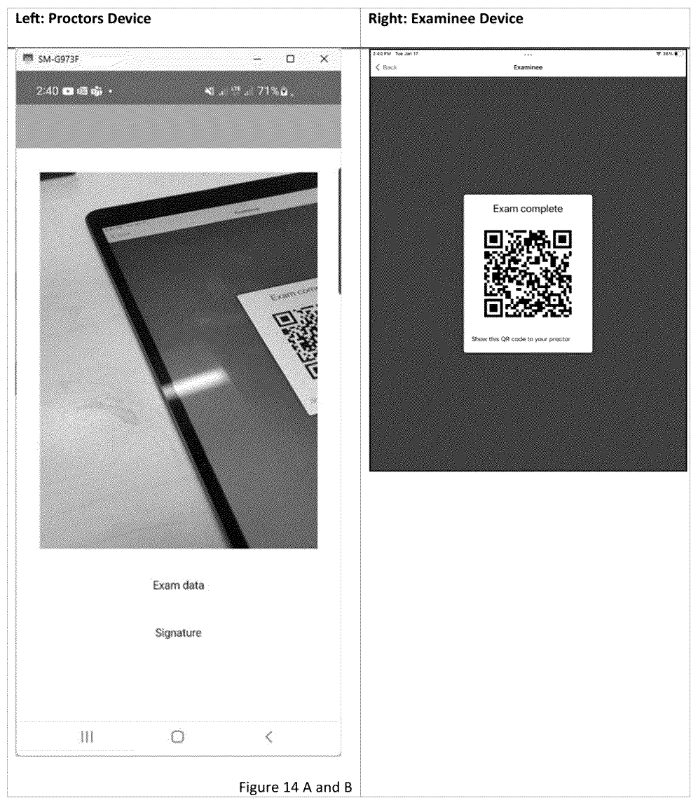

FIG. 14A shows the screen on the proctor device as the proctor selects the ‘Accept result’ button to open the QR code scanner on the proctor device, which is then used to read the examinee's exam completion QR code, as shown in FIG. 14B, thus transferring the data to the proctor device. The QR code could also be shared via device-to-device communication such as text or email. A copy of the exam data is now stored on the proctor device.

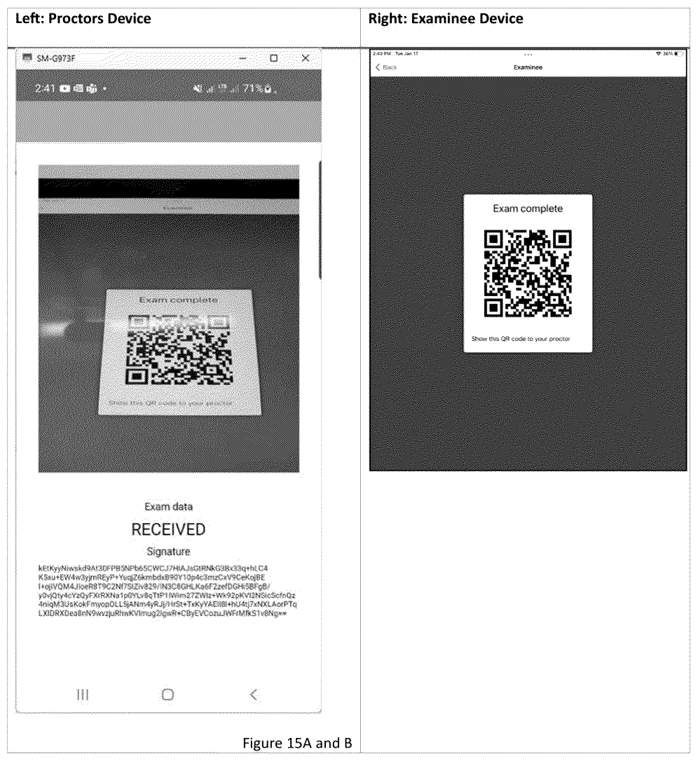

FIGS. 15A-15B show the screens after the exam data has been transferred to the proctor's device and is stored there to be transmitted to the central server when an online connection is available between the proctor device and the central server. This could be immediately, or sometime after completion of the exam. To safeguard against data loss, the proctor can use their private key to create a cryptographic signature of the exam data. The encrypted data can be passed back to the examinee, who then has independent verification both that the exam has been completed but also that it has been certified so by the proctor. Even if the proctor's copy of the data is lost, the examinee can transmit the exam data and signature to the server instead, so they can claim their score and certificate with no potential for tampering or fraud.

In the foregoing process, any individual step or combination of steps may be conducted automatically via connection to the central server, if such a connection happens to be available as needed to allow this, without hindering the ability for the remaining steps to be conducted in the disconnected fashion shown above if the connection is no longer available.

In the manner described herein, the present invention accomplishes a number of objectives, including: (1) providing a system and method for using either peer-to-peer networking or non-network communication methods (such as a camera and QR code, or data provided verbally by one party and typed by the other) to enable an exam environment that is highly resilient to central (LAN, Internet, etc.) network interruptions, or even an exam administered digitally without any such central network available from start to finish; (2) providing a system and method for encrypting exam data on an examinee device until the exam starts, such that all students can begin the exam at the same time without any device-to-device interaction of any kind by the verbal provision of the decryption key by a proctor; (3) providing a system and method for re-securing exam data after the exam starts (when the exam data must be decrypted and thus made unsecure in order to allow the user to take the test) multiple times and for a variety of reasons, such as a device going to sleep or leaving a designated area, examinee misbehavior, or for other reasons, where an individual action by the proctor is able to unlock only an intended examinee's device, and only one time—the method prevents the unlock mechanism from being used later again by the same examinee, or for a different examinee's locked exam; and (4) providing a system and method for ensuring that, even if no Internet connection is available on either device when the exam ends, either the proctor or the examinee can transmit the examinee's test answer data back to the central server, with public key cryptography ensuring that the data was certified and accepted by the proctor.

The present invention substantially eliminates the problems of the prior art by providing a system and method that enables a proctor to safely and securing administer an exam in connection with a remote network central connection, without necessarily maintaining a constant connection therewith. The invention is not dependent on maintaining a multi-access point computer network connection between the devices of multiple test takers. Instead, the invention can utilize a combination of proctor to examinee device level and physical interaction, with the central network connection updated on the results on as available basis.

The loss of the network connection is no longer an event that can disrupt the examination, which can continue unaffected thereby. Such loss of connection becomes a more substantial risk, and the number of examinees increase, however, the present invention is immune from this risk.

The present invention accomplishes the foregoing in a manner that exchanges information securely through the use of encryption technology, such that neither the examination nor the various devices used in connection therewith are put at risk.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A method of proctoring an examination carried out by a plurality of computer devices under the operation computer programing instructions, comprising:
a. providing a proctor with a proctor device executing computer code for carrying out the steps of this invention;
b. providing am examinee with an examine device executing computer code for carrying out the steps of this invention;
c. delivering to the proctor an electronic examination form encrypted with a start key for use by the examinee on the examinee device;
d. delivering the encrypted examination form to the examinee;
e. starting the exam by providing the start key to the examinee allowing decryption of the examination form on the examinee device.

2. The method of claim 1 further comprising the steps of delivering to the proctor a public and private encryption key, and delivering the public key to the examinee.

3. The method of claim 2 further comprising the steps of encrypting the electronic examination form on the examinee device with a key upon detecting of an insecure situation, and encrypting the key with the proctor's public key.

4. The method of claim 3 further comprising the step of displaying the key encrypted with the proctor's public key on the examinee's device.

5. The method of claim 4 further comprising the step of using the proctor's private key to decrypt the key and storing the key on the proctor's device.

6. The method of claim 5 further comprising the step of providing the key to the examinee upon resolution of the insecure situation to allow the examinee to decrypt the electronic examination form.

7. The method of claim 1 where the electronic examination form is provided from a centralized computer server.

8. The method of claim 1 further comprising the step of encrypting on the examiner's device the answers to the electronic examination using the proctor's public key.

9. The method of claim 8 further comprising the step of delivering the encrypted answers to the proctor's device.

10. The method of claim 9 further comprising the step of generating a certificate of completion of the exam by generating a digital signature using the proctor's private key.

11. The method of claim 10 further comprising the step of communicating the encrypted answers and signature to the examinee's device.

12. The method of claim 11 further comprising the step of providing the answers and signature to an examination authority to register completion of the electronic examination by the examinee.

13. The method of claim 1 further comprising multiple examinees and examinee devices.
